(19) United States
(12) Patent Application Publication
(10) Pub. No.: US 2008/0310803 A1
(43) Pub. Date: Dec. 18, 2008

(54) Fibre Optic Ribbon with Several Individual Optical Fibres and Method for Production Thereof

(75) Inventors: Martin Franke, Berlin (DE); Tobias Happel, Berlin (DE); Mathias Miedreich, Neumarkt (DE); Helmut Nowsch, Regensburg (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/792,717

(22) PCT Filed: Dec. 6, 2005
(86) PCT No.: PCT/EP05/56496

§ 371 Date: Apr. 30, 2008

(30) Foreign Application Priority Data
Dec. 9, 2004 (DE) 10 2004 059 932.7

(51) Int. Cl. G02B 6/04

(52) U.S. Cl. 385/115

(57) ABSTRACT

A fibre optic ribbon has several individual optical fibres, provided, for example, for application of the ribbon conductor as flex sensor trip, with surface-treated partial regions in which individual optical fibres can be provided. The individual fibres are arranged in a support strip with a space between, such that a treatment of the individual fibres, which permits a particularly simple execution of the surface treatment. The individual fibres are treated with removal of the support strip in the partial regions and finally the support strip is provided with a sleeve. Additional passive optical fibres can be inserted in the spaces for protection of the individual fibres during the surface treatment which give additional protection to the individual fibres.

### CROSS REFERENCE TO RELATED APPLICATIONS

This application is based on and hereby claims priority to PCT Application No. PCT/EP/2005/056496 filed Dec. 6, 2005 and German Application No. 10 2004 059 932.7 filed on Dec. 9, 2004, the contents of which are herby incorporated by reference.

### BACKGROUND OF THE INVENTION

The invention relates to a ribbon-shaped light guide with a multiplicity of parallel running individual optical fibers that are surrounded by a cladding; provided in the cladding is a carrier tape in which the individual fibers are fully embedded while respectively observing an interspace between neighboring individual fibers.

A ribbon-shaped light guide of the type specified at the beginning is disclosed, for example, in DE 690 23 799 T2. This light guide has a plurality of individual fibers that are supported in a longitudinally foldable cladding. The cladding further makes available in the interior a structure that leads to a local deformation of the light guides running in the interior upon exertion of a pressure on the top side or underside of the ribbon formed by the cladding. This deformation effects the attenuation response of the individual fibers such that evaluation of a light signal guided through the individual fibers makes available a sensor signal that renders possible a measure of the pressure acting locally on the cladding.

Light guiding cables in which individual optical fibers are processed to form a bundle are disclosed in DE 33 28 948 A1, DE 44 16 545 A1 and DE 93 21 083 U1. These are provided as bundles with cladding, it also being possible for the bundle to comprise light guides arranged next to one another in a plane, the cable thereby acquiring a ribbon-shaped cross section. Furthermore, in accordance with DE 93 21 083 U1 it is possible for the individual fibers of the light guide firstly to be embedded in a ribbon-shaped optical waveguide element, and for the latter in turn to be pushed into a chamber-like cutout in an extruded plastic ribbon. This gives rise to a light guide that exhibits an improved resistance against mechanical stresses to the optical waveguide.

### SUMMARY OF THE INVENTION

One possible object is to specify a ribbon-shaped light guide that can be easily produced and in this case generates comparatively reliable sensor signals.

The inventors propose a ribbon-shaped light guide having individual fibers that respectively exhibit a surface structure increasing the optical attenuation response in defined segments. These surface structures can be produced with the aid of different treatment methods for the surface of the individual fibers, it being possible for the material of the carrier tape to be simultaneously removed from the individual fibers. When the attenuation response of the individual fibers in the defined segments is boosted, it is advantageously possible to determine an alteration in the curvature of the individual fibers in these segments with increased sensitivity. As already mentioned, it is thereby possible for the light guide to be used as sensor ribbon for deformations in curvature.

The carrier tape fulfills two tasks here. Firstly, reliable fixing of the individual fibers is achieved by the carrier tape, and so it is ensured that individual fibers are reliably positioned inside the tape even when the ribbon-shaped light guide is laid as sensor ribbon. This positioning is also maintained even when the sensor tape follows a predetermined curve shape, as is the case, for example, when the ribbon-shaped light guide is laid as pedestrian sensor in the fender of a motor vehicle. The second task relates to reliably maintaining an interspace between the individual fibers such that the latter can be subjected to a further surface treatment after fixing on the carrier tape. In this case, the surface structuring of the individual fibers can be altered in segments in order to influence the attenuation response in a targeted fashion in these segments. These segments are then the sensitive zones that react with a measurable change in their attenuation response upon an alteration in the curvature of the individual fibers.

Owing to the prior fixing of the individual fibers on a carrier tape before a treatment of the surface of the individual fibers, it is advantageously possible to carry out a cost effective treatment method, since the combination of individual fibers on the carrier tape is easy to handle and, moreover, a plurality of individual fibers can be subjected simultaneously to a treatment. Even when a treatment method affected by tolerances is applied, the interspaces between the individual fibers ensure that in each case it is only the surface structure of the desired individual fiber that is altered without there being the risk that possible neighboring individual fibers could be damaged in an undesired fashion by the treatment method.

It is also provided that the individual fibers are fully embedded in the carrier tape. It is thereby advantageously possible to fix the individual fibers over the entire circumference of their cross section, as a result of which a particularly secure fixing can be performed. Moreover, the interspaces between the individual fibers are then filled with the material of the carrier tape such that the latter is thereby additionally stiffened and, moreover, a protective action is developed during operation of the ribbon-shaped light guide.

Moreover, it can be provided that passive fibers are arranged in the interspaces. This has the particular advantage that the production of the light guide is simplified, since the passive fibers throughout the interspaces such that the observation of the interspaces between the individual fibers is automatically ensured. Moreover, the optically passive fibers can be formed from a material that is stable in relation to the individual fibers, in order to attain an additional stiffening of the ribbon-shaped light guide. The passive fibers can, in particular, be formed of an optically passive material, that is to say said material exhibits no light guiding properties. However, if the fibers are light guiding they are not used as light guides during operation of the sensor ribbon, and therefore remain passive since they play no part in the generation of the optical measurement result.

It is advantageous when the carrier tape is formed of a material that can be removed by laser ablation. The carrier tape with the individual fibers is thereby accessible to laser machining and so it is advantageously possible in one step both to remove the material of the carrier tape and to treat the surface of the unexposed individual fibers.

Referring to DE 690 23 799 a method for forming a ribbon-shaped light guide comprises at least the parallel running arrangement of a plurality of individual fibers and the subsequent cladding thereof such that said fibers are fixed inside the ribbon formed by the cladding.

Consequently, another possible object is to specify a method for producing a ribbon-shaped light guide that can be carried out easily.

The inventors propose a method in which individual optical fibers are fixed parallel to one another with the aid of a carrier tape while observing respective interspaces, the surface structure of the individual fibers is altered in defined segments, and the carrier tape with the individual fibers is provided with a cladding. Owing to the use of a carrier tape for affixing the individual fibers, it is advantageously possible to ensure that the ribbon-shaped light guide is produced cost effectively and on a large scale, as has already been explained more precisely. In particular, the fixing renders possible a simple surface treatment of the individual fibers in respective segments in order to produce an optical sensor ribbon. In this case, the parallel running individual fibers can be treated in one production step, in which case manufacturing inaccuracies that may arise in the surface treatment are of no import, since owing to the observance of the interspaces between the individual fibers despite the tolerances occurring the neighboring individual fibers are not endangered by the surface treatment.

During treatment by the laser 15, interspaces 16 between the individual fibers 12 have the effect that the respectively neighboring individual fibers are not affected during the treatment. The neighboring individual fibers therefore also lie outside the region still acted upon by the laser despite possible focusing, and so it is possible to exclude the neighboring individual fibers from being influenced in any case.

In order to reliably prevent respectively neighboring individual fibers from being damaged during surface treatment of the desired fibers, it is advantageous to dimension the interspaces 16 with a size that, taking account of the manufacturing tolerances, respectively prevents undesired damage to the individual fibers lying next to the segment to be treated during the alteration of the surface structure. It therefore follows that the size of the interspace is a function of the accuracy of the surface treatment method. For example, it is necessary when treating the surface by a laser to ensure that build up of heat arising in the process does not influence the neighboring individual fibers. The accuracy of such a treatment method is therefore a function not only of the guidance of the laser and the focusing of the latter, but also of the build up of energy at the treatment site.

It is, furthermore, advantageous when the individual fibers are fully embedded in the carrier tape, and the part of the carrier tape covering the segments is removed before the alteration of the surface structure. It follows that it is possible outside the corresponding segments for the individual fibers to be advantageously guided in the carrier tape particularly reliably. The fixing also remains in existence even when the ribbon-shaped light guide is, for example, laid as sensor ribbon in the curved state. This is particularly important, since the surface treated segments must respectively lie in the regions of the curvature of the sensor ribbon that is to be expected and detected, and are therefore not allowed to experience twisting inside the carrier tape.

When use is made of a carrier tape, fully embedding the individual fibers, it is particularly advantageous if the partial removal of the carrier tape and the alteration of the surface structure of the segments is undertaken with a laser. These two production steps can then, specifically, be combined in a single production step, the energy input by the laser into the carrier tape being set such that it suffices for simultaneously removing the layer of the carrier tape on the individual guide, and for ensuring the desired surface treatment of the individual guide.

### BRIEF DESCRIPTION OF THE DRAWING

These and other objects and advantages of the present invention will become more apparent and more readily appreciated from the following description of the preferred embodiments, taken in conjunction with the accompanying drawings of which:

FIG. 1 shows the cross section of a first exemplary embodiment of the ribbon-shaped like guide, and

FIG. 2 shows the cross section of an alternative exemplary embodiment of the ribbon-shaped guide.

### DETAILED DESCRIPTION OF THE DRAWINGS

Reference will now be made in detail to the preferred embodiments of the present invention, examples of which are illustrated in the accompanying drawings, wherein like reference numerals refer to like elements throughout.

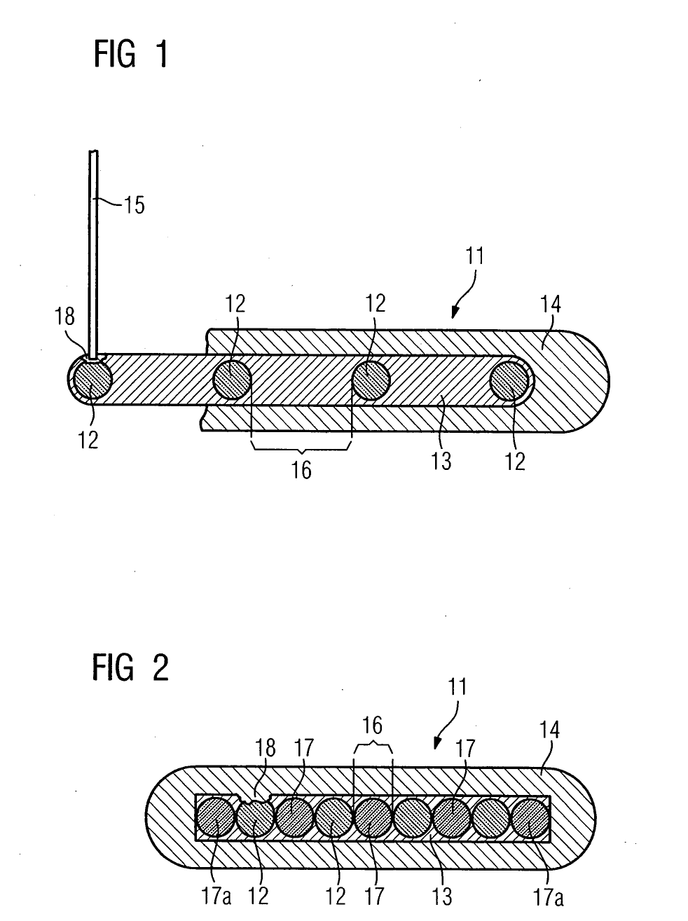

A ribbon-shaped light guide 11 in accordance with FIG. 1 has four individual fibers 12 that are completely enclosed in a carrier tape 13. In this state, that is to say without a cladding 14 (illustrated on the left hand side of the carrier tape) surrounding the carrier tape, a laser 15 that is indicated can be used to remove the material of the carrier tape in a subregion 18 of the relevant individual fiber 12, and to provide the surface with a structuring that increases its attenuation response. If laser treatment is carried out only from one side of the carrier tape (from above in FIG. 1), this method can advantageously be carried out with particular ease, since there is no need to turn the carrier tape. In order for the surface treated subregions to be aligned uniquely in the carrier tape, it is necessary to embed the individual fibers 12 fully in the carrier tape 13, the enclosure preventing rotation of the individual fibers inside the ribbon guide 12 because of the adhesion at the interfaces between individual fibers 12 and carrier tape 13. It follows that twisting of the surface treated subregions 18 is also counteracted.

After laser treatment, the carrier tape 13 is inserted into the cladding 14 (for example by extrusion coating of the carrier tape). The instances of damage introduced into the carrier tape 13 during surface treatment of the individual fibers 12 are thereby also filled up such that the individual fibers 12 are again fully surrounded by a protective material. The material of the cladding 14 can, furthermore, be selected such that said material ensures effective protection against environmental influences at the site of use of the ribbon-shaped light guide.

The ribbon-shaped light guide in accordance with FIG. 2 has a similar design. However, there are arranged in the interspaces 16 optically passive fibers 17 that define the width of the interspace. During laser treatment (not illustrated in FIG. 2) these can absorb additional radiation energy of the laser in order to protect the respectively neighboring individual fibers 12. In addition, a protective function or a stiffening of the ribbon-shaped light guide 11 is possible given suitable selection of the material of the optically passive fibers. Apart from being arranged in the interspaces 16, an optically passive fiber 17a can also respectively be arranged beyond the outermost individual fiber 12. The same production conditions for the surface structuring of the individual fibers 12 are thereby also provided in this region. Carrying out the surface treatment of the individual fibers is thereby simplified, since said surface treatment can be carried out for all individual fibers with exactly the same production parameters.

A segment 18 of one of the individual fibers 12 is furthermore to be seen in FIG. 2, a surface structuring being indicated. Otherwise, it may be seen that the material of the carrier tape 13 is removed in this region, this region being filled up by the material of the cladding 14 instead of that of the carrier tape.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-7. (canceled)

8. A ribbon-shaped light guide comprising:
a plurality of parallel running individual optical fibers;
a cladding surrounding the optical fibers;
a carrier tape provided within the cladding, the optical fibers being fully embedded in the carrier tape with an interspace provided between neighboring optical fibers, the carrier tape being selectively removed from at least one individual optical fiber in defined segments so that the at least one individual optical fiber exhibits a surface structure with increased the optical attenuation in the defined segments.

9. The light guide as claimed in claim 8, wherein passive fibers are arranged in the interspaces.

10. The light guide as claimed in claim 8, wherein the carrier tape is formed of a material that can be removed by laser ablation.

11. The light guide as claimed in claim 9, wherein the carrier tape is formed of a material that can be removed by laser ablation.

12. A method for producing a ribbon-shaped light guide, comprising:
fixing individual optical fibers in parallel to one another within a carrier tape, the individual optical fibers being fixed in parallel with interspaces therebetween;
after fixing the individual optical fibers, altering a surface structure of at least one individual optical fiber in defined segments; and
after altering the surface structure, providing a cladding around the carrier tape with the individual optical fibers therein.

13. The method as claimed in claim 12, wherein the interspaces are dimensioned with a size that, taking account of manufacturing tolerances, prevents undesired damage to the optical fibers lying next to the at least one individual optical fiber to be treated during alteration of the surface structure.

14. The method as claimed in claim 12, wherein
the individual fibers are initially fully embedded in the carrier tape, and
the carrier tape covering the segments is removed before altering the surface structure.

15. The method as claimed in claim 14, wherein partial removal of the carrier tape and alteration of the surface structure are undertaken with a laser.

16. The method as claimed in claim 13, wherein
the individual fibers are initially fully embedded in the carrier tape, and
the carrier tape covering the segments is removed before altering the surface structure.

17. The method as claimed in claim 16, wherein partial removal of the carrier tape and alteration of the surface structure are undertaken with a laser.
